(19) United States
(12) Patent Application Publication
(10) Pub. No.: US 2026/0257247 A1
(43) Pub. Date: Sep. 3, 2026

(54) CLEANING KIT

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 18/995,611

(22) PCT Filed: Jul. 21, 2023
(86) PCT No.: PCT/KR2023/010538

§ 371 Date: Jan. 16, 2025

(30) Foreign Application Priority Data
Jul. 28, 2022 (KR) 10-2022-0093645

(51) Int. Cl. B08B 1/16; A24F 9/04; A24F 40/85

(52) U.S. Cl. CPC B08B 1/165; A24F 9/04; A24F 40/85

(57) ABSTRACT

The present disclosure relates to a cleaning kit configured to clean an aerosol generating device. The cleaning kit includes: a rod that is elongated in a longitudinal direction; a first blade protruding from one end of the rod; a second blade protruding from another end of the rod, wherein the second blade is shaped to define a blade hole at an end of the second blade and along the longitudinal direction of the rod; and a pin protruding from an end of the first blade.

### TECHNICAL FIELD

The present disclosure relates to a cleaning kit for cleaning an aerosol generating device.

### BACKGROUND ART

An aerosol generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE

### Technical Problem

It is an objective of the present disclosure to solve the above and other problems.

It is another objective of the present disclosure to provide a cleaning kit that can improve the cleaning performance and convenience of an aerosol generating device.

It is yet another objective of the present disclosure to provide a cleaning kit that can clean various objects.

It is yet another objective of the present disclosure to provide a cleaning kit that can be manufactured in a compact size.

### Technical Solution

According to one aspect of the subject matter described in this application, a cleaning kit includes: a rod that is elongated in a longitudinal direction; a first blade protruding from one end of the rod; a second blade protruding from another end of the rod, wherein the second blade is shaped to define a blade hole at an end of the second blade and along the longitudinal direction of the rod; and a pin protruding from an end of the first blade.

### Advantageous Effects

According to at least one of the embodiments of the present disclosure, a cleaning kit capable of improving the cleaning performance and convenience of an aerosol generating device may be provided.

According to at least one of the embodiments of the present disclosure, a cleaning kit suitable for cleaning various objects may be provided.

According to at least one of the embodiments of the present disclosure, a cleaning kit capable of being manufactured in a compact size may be provided.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### DESCRIPTION OF DRAWINGS

FIGS. 1 and 2 illustrate examples of an aerosol generating device related to the present disclosure.

FIGS. 3 to 36 illustrate examples of a cleaning kit according to embodiments of the present disclosure.

### MODE FOR INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

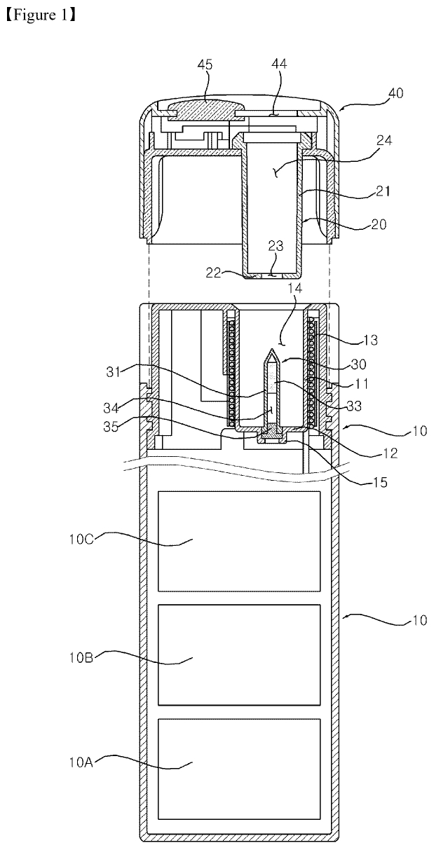

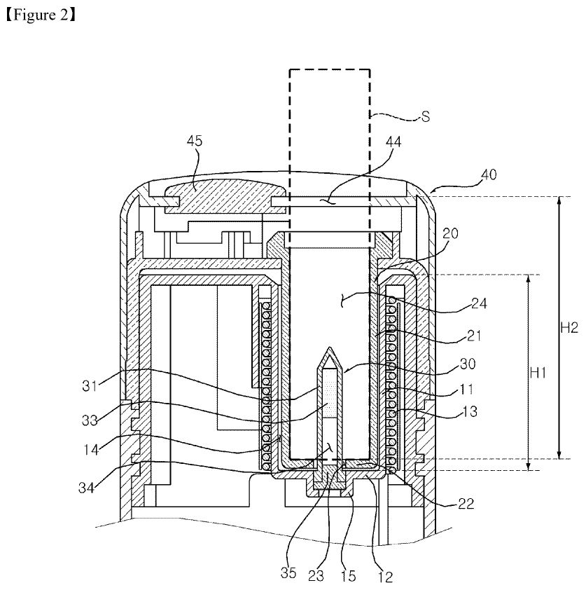

Referring to FIGS. 1 and 2, an aerosol generating device may include at least one of a battery 10A, a controller 10B, and a sensor 10C. At least one of the battery 10A, the controller 10B, and the sensor 10C may be disposed inside a body 10 of the aerosol generating device.

The body 10 may include a pipe (11, 12) defining a first insertion space 14. The first insertion space 14 may be formed in an upper portion of the body 10. The first insertion space 14 may be open at top. The first insertion space 14 may have a cylindrical shape elongated up and down or vertically. A first lateral wall 11 of the pipe (11, 12) may surround a lateral portion of the first insertion space 14. A first flange 12 of the pipe (11, 12) may cover a lower portion of the first insertion space 14.

An extractor 20 may include a second insertion space 24. The second insertion space 24 may be open at a top of the extractor 20. The second insertion space 24 may have a cylindrical shape elongated vertically. A second lateral wall 21 of the extractor 20 may cover a lateral portion of the second insertion space 24. A second flange 22 of the extractor 20 may cover a lower portion of the second insertion space 24. A center of the second flange 22 may be open to define a through-hole 23.

The extractor 20 may be inserted into the first insertion space 14. When the extractor 20 is inserted into the first insertion space 14, the second insertion space 24 may be disposed inside the first insertion space 14. The second insertion space 24 may be open at a top of the body 10. A diameter of the second insertion space 24 may be less than a diameter of the first insertion space 14. The first insertion space 14 and the second insertion space 24 may communicate with each other via the through-hole 23.

A heater assembly 30 may be fixed to the body 10. The heater assembly 30 may protrude long upward from the first flange 12 in the first insertion space 14. The heater assembly 30 may pass through the through-hole 23. An upper portion of the heater assembly 30 may be disposed in the second insertion space 24 through the through-hole 23. The heater assembly 30 may heat the second insertion space 24.

The heater assembly 30 may include a heater rod 31 and a heater 33. The heater rod 31 may protrude upward from the first flange 31 toward the first insertion space 14. The heater rod 31 may be elongated vertically. A body of the heater rod 31 may have a cylindrical shape. The heater rod 31 may have a pointed upper end (or top).

The heater 33 may be inserted into a cavity 34 of the heater rod 31. The heater 33 may be fixed inside the heater rod 31. The cavity 34 may be open at bottom, which may be covered by a heater cap 35. The first flange 12 may be recessed downward to define a heater mount 15. A lower end of the heater rod 31 and the heater cap 35 may be fixed to the heater mount 15.

The heater 33 may be a resistive heater. When the heater 33 generates heat, the heat may pass through the heater rod 31 to thereby heat the second insertion space 24. An induction coil 13 may allow the heater 33 to generate heat. The induction coil 13 may be vertically wound around the first lateral wall 11, and may surround the first insertion space 14 and the heater 33. The heater 33, which is a susceptor, may generate heat by a magnetic field produced by an AC current flowing through the induction coil 13. The magnetic field may pass through the heater 33, and may generate an eddy current in the heater 33. The current may cause the heater 33 to generate heat. Alternatively, unlike shown, the heater 33 may generate heat using power supplied directly thereto.

An upper case 40 may be detachably coupled to the body 10. The upper case 40 may cover an upper portion of the body 10 around the first insertion space 14. The extractor 40 may be coupled to the upper case 40 so as to act in conjunction with the upper case 40. When the upper case 40 is coupled to the body 10, the extractor 20 may be inserted into the first insertion space 14, and the heater assembly 30 may pass through the through-hole 23 of the second flange 22 to be disposed in the second insertion space 24.

The upper case 40 may have an insertion hole 44. The insertion hole 44 may be aligned above the second insertion space 24 of the extractor 40 with the second insertion space 24. The insertion hole 44 may have a circular cross section. A cover 45 may be movably installed on the upper case 40. The cover 45 may open and close the insertion hole 44 and the second insertion space 24.

The battery 10A may supply power to operate components of the aerosol generating device. The battery 10A may supply power to at least one of the controller 10B, the sensor 10C, the induction coil 13, and the heater assembly 30. The battery 10A may supply power required to operate a display, a motor, and the like installed at the aerosol generating device.

The controller 10B may control the overall operation of the aerosol generating device. The controller 10B may control the operation of at least one of the battery 10A, the induction coil 13, and the sensor 10C. The controller 10B may control the operation of the display, the motor, and the like installed at the aerosol generating device. The controller 10B may check the state of each of the components of the aerosol generating device to determine whether the aerosol generating device is in an operable state.

The sensor 10C may sense a temperature of the heater 33. The controller 10B may control the temperature of the heater 33 based on the temperature sensed by the sensor 10C. The controller 10B may transmit, through a user interface, information regarding the temperature of the heater 33 sensed by the sensor 10C to a user.

A stick S may be inserted into the second insertion space 24. The stick S may pass through the insertion hole 44 to be inserted into the second insertion space 24. An upper portion of the stick S may be exposed at the top of the extractor 20 and the upper case 40. The stick S may be supported by the second lateral wall 21 and the second flange 22 in the second insertion space 24. The heater rod 31 formed through the through-hole 23 may be inserted into a lower portion of the stick S that is inserted into the second insertion space. The stick S may be heated by the heater 33 in the heater rod 31, thereby generating an aerosol.

A user may inhale air while holding one end of the stick S, which is exposed to the outside, in his or her mouth. Air may be introduced into the stick S through the through-hole 23 to carry the aerosol, and then be delivered to the user.

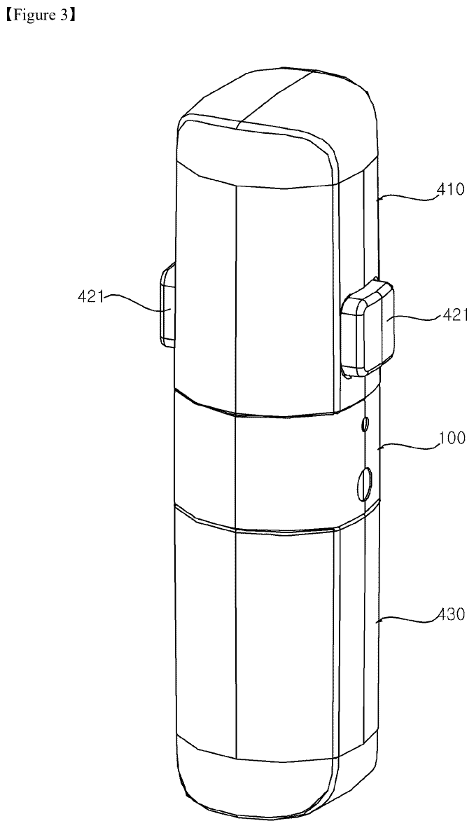

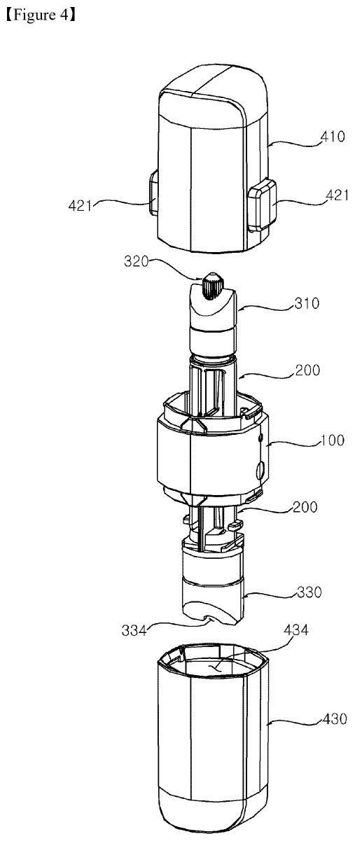

Referring to FIGS. 3 and 4, a cleaning kit may be a tool for cleaning the first insertion space 14 and the second insertion space 24 of the aerosol generating device. The cleaning kit may include a frame 100 and a rod 200. The rod 200 may be elongated up and down or vertically. An outer circumferential surface of the rod 200 may have a curved shape extending in a circumferential direction. The rod 200 may be coupled to an inside of the frame 100. An upper end of the rod 200 may protrude above the frame 100. A lower end of the rod 200 may protrude below the frame 100. The frame 100 may surround an outside of a middle portion of the rod 200 in a transverse or horizontal direction.

The cleaning kit may include a first blade 310. The first blade 310 may be fixed to a top of the rod 200. The first blade 310 may include a portion of a cylindrical shape. An upper portion of the first blade 310 may have a tip shape that tapers upward from the cylindrical portion. An outer circumferential surface of the first blade 310 may be aligned with the outer circumferential surface of the rod 200. The first blade 310 may be referred to as an upper blade 310.

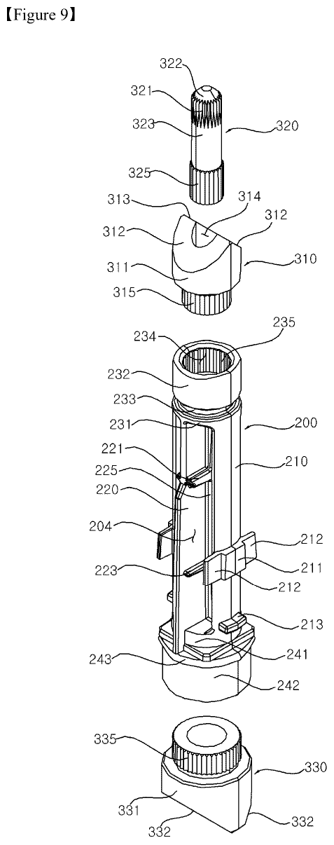

The cleaning kit may include a pin 320. The pin 320 may be inserted into and fixed to a first blade hole 314 (see FIG. 9) of a cylindrical shape formed by opening a center of the first blade 310. The pin 320 may protrude upward from an upper end of the first blade 310. The pin 320 may include a portion of a cylindrical shape. An upper portion of the pin 320 may have a tip shape that tapers upward from the cylindrical portion.

The cleaning kit may include a second blade 330. The second blade 330 may be fixed to a bottom of the rod 200. The second blade 330 may include a portion of a cylindrical shape. A lower portion of the second blade 330 may have a tip shape that tapers downward from the cylindrical portion. A center of the second blade 330 may be open to define a second blade hole 334. The second blade hole 334 may have a cylindrical shape. An outer circumferential surface of the second blade 330 may be aligned with the outer circumferential surface of the rod 200. The second blade 330 may be referred to as a lower blade 330.

The cleaning kit may include a first cap 410. The first cap 410 may be detachably coupled to one side of the frame 100. The first cap 410 may cover the upper end of the rod 200 and the first blade 310. The first cap 410 may be referred to as an upper cap 410.

The cleaning kit may include a second cap 430. The second cap 430 may be detachably coupled to another side of the frame 100. The second cap 430 may cover the lower end of the rod 200 and the second blade 330. The second cap 430 may be referred to as a lower cap 430.

The first cap 410 and the second cap 430 may be disposed opposite each other with the frame 100 interposed therebetween. In a state where the first cap 410 and the second cap 430 are coupled to the frame 100, an outer circumferential surface of the frame 100 may be exposed to the outside between the first cap 410 and the second cap 430. In a state where the first cap 410 and the second cap 430 are coupled to the frame 100, a user may remove the first cap 410 or the second cap 430 from the frame 100 while holding the outer circumferential surface of the frame 100.

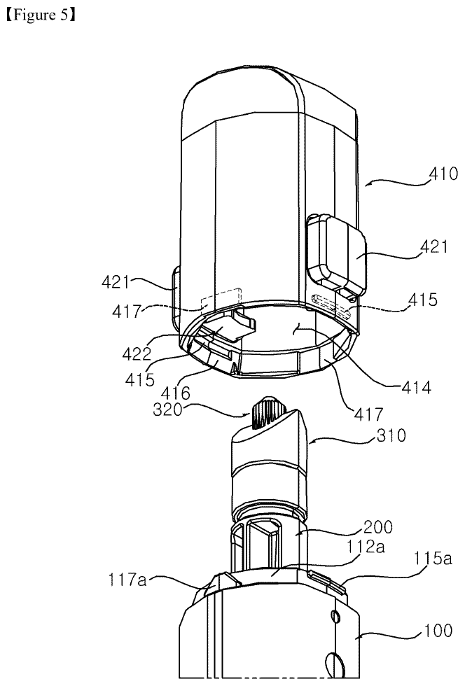

Referring to FIG. 5, the first cap 410 may be coupled to an upper portion of the frame 100. The first cap 410 may include therein a first chamber 414 that is open at bottom. An upper end of the rod 200, the first blade 310, and the pin 320 may be inserted into the first chamber 414, so as to be protected from the outside by the first cap 410.

An upper outer circumferential surface of the frame 100 may be recessed inward to define a first recessed portion 112a. The first recessed portion 112a may have a shape corresponding to a lower inner circumferential surface of the first cap 410. The lower inner circumferential surface of the first cap 410 may surround an outer circumferential surface of the first recessed portion 112a.

A first coupling protrusion 115a may be formed at an upper end of the frame 100. The first coupling protrusions 115a may be provided on opposite sides with respect to the frame 100. The first coupling protrusion 115a may protrude outward from the outer circumferential surface of the first recessed portion 112a. The lower inner circumferential surface of the first cap 410 may be recessed to define a first coupling groove 415. The first coupling groove 415 may be formed at a position corresponding to the first coupling protrusion 115a. The first coupling protrusion 115a may be inserted into the first coupling groove 415, so that the first cap 410 and the frame 100 may be coupled to each other. The first coupling protrusion 115a and the first coupling groove 415 may be detachably coupled to each other in a snap-fit manner.

A first protrusion guide 416 may be formed on a lower side of the first coupling groove 415. The first protrusion guide 416 may be inclined outward from the first coupling groove 415 toward a lower end of the first cap 410. The first protrusion guide 416 may guide the first coupling protrusion 115a to the first coupling groove 415.

A first cap guide 117a may be formed at the upper portion of the frame 100. The first cap guide 117a may protrude from the first recessed portion 112a. The first cap guide 117a may have a shape that tapers upward. The first cap guides 117a may be disposed on opposite sides with respect to the frame 100. The lower inner circumferential surface of the first cap 410 may be recessed to define a first guide groove 417. The first guide groove 417 may be open at bottom. The first guide groove 417 may be formed at a position corresponding to the first cap guide 117a. The first cap guide 117a may be inserted into the first guide groove 417 so as to allow the first cap 410 to be aligned in place.

Accordingly, the first cap 410 may be detachably coupled to the frame 100. In addition, the first cap 410 may be coupled to the frame 100 while being properly aligned with respect to the frame 100.

A first pusher 421 may be coupled to the first cap 410. The first pusher 421 may protrude outward from an outer circumferential surface of the first cap 410. A second pusher 422 interlocked with the first pusher 421 may protrude inward from an inner circumferential surface of the first cap 410 toward the first chamber 414. The second pusher 422 may be curved in a shape corresponding to an outer circumferential surface of the rod 200. The first pusher 421 and the second pusher 422 may be disposed on opposite sides with respect to the first cap 410. The second pusher 422 may support the rod 200. The second pusher 422 may slide on an outer circumferential surface of the first blade 310 and the outer circumferential surface of the rod 200. The first pusher 421 may be referred to as an outer pusher 421. The second pusher 422 may be referred to as an inner pusher 422.

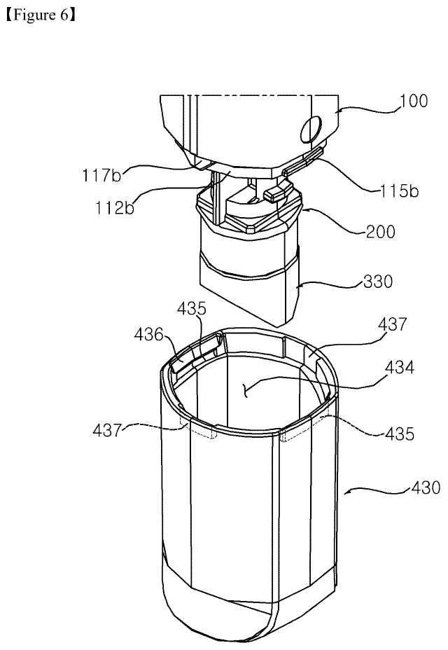

Referring to FIG. 6, the second cap 430 may be coupled to a lower portion of the frame 100. The second cap 430 may include therein a second chamber 434 that is open at top. A lower end of the rod 200 and the second blade 330 may be inserted into the second chamber 434, so as to be protected from the outside by the second cap 430.

A lower outer circumferential surface of the frame 100 may be recessed inward to define a second recessed portion 112b. The second recessed portion 112b may have a shape corresponding to an upper inner circumferential surface of the second cap 430. The upper inner circumferential surface of the second cap 430 may surround an outer circumferential surface of the second recessed portion 112b.

A second coupling protrusion 115b may be formed at a lower end of the frame 100. The second coupling protrusions 115b may be disposed on opposite sides with respect to the frame 100. The second coupling protrusion 115b may protrude outward from the outer circumferential surface of the second recessed portion 112b. The upper inner circumferential surface of the second cap 430 may be recessed to define a second coupling groove 435. The second coupling groove 435 may be formed at a position corresponding to the second coupling protrusion 115b. The second coupling protrusion 115b may be inserted into the second coupling groove 435, so that the second cap 430 and the frame 100 may be coupled to each other. The second coupling protrusion 115b and the second coupling groove 435 may be detachably coupled to each other in a snap-fit manner.

A second protrusion guide 436 may be formed on an upper side of the second coupling groove 435. The second protrusion guide 436 may be inclined outward from the second coupling groove 435 toward an upper end of the second cap 430. The second protrusion guide 436 may guide the second coupling protrusion 115b to the second coupling groove 435.

A second cap guide 117b may be formed at the lower portion of the frame 100. The second cap guide 117b may protrude from the second recessed portion 112b. The second cap guide 117b may have a shape that tapers downward. The second cap guides 117b may be disposed on opposite sides with respect to the frame 100. The upper inner circumferential surface of the second cap 430 may be recessed to define a second guide groove 437. The second guide groove 437 may be open at top. The second guide groove 437 may be formed at a position corresponding to the second cap guide 117b. The second cap guide 117b may be inserted into the second guide groove 437 so as to allow the second cap 430 to be aligned in place.

Accordingly, the second cap 430 may be detachably coupled to the frame 100. In addition, the second cap 430 may be coupled to the frame 100 while being properly aligned with respect to the frame 100.

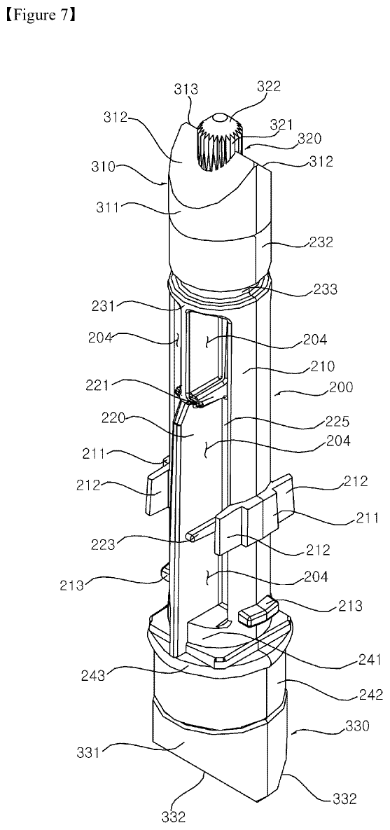

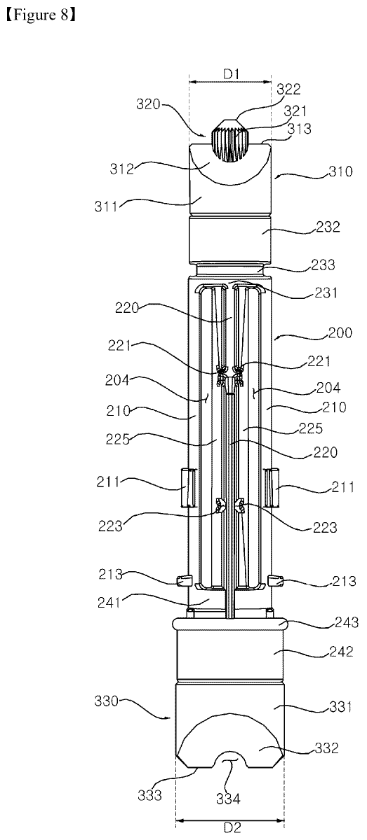

Referring to FIGS. 7 and 8, the rod 200 may include a first rod 210 and a second rod 220. The first rod 210 and the second rod 220 may be elongated vertically. A pair of first rods 210 may be disposed on opposite sides with respect to the second rod 220. The second rod 220 may be provided between the pair of first rods 210. The first rod 210 may be spaced apart from the second rod 220 by a predetermined distance. The first rod 210 and the second rod 220 may be parallel to each other. An outer surface of the first rod 210 may bulge outward. The second rod 220 may have a plate shape elongated vertically.

The first rod 210 may be spaced apart from the second rod 220 in a thickness direction of the second rod 220. A slit 204 may be formed between the first rod 210 and the second rod 220. The slit 204 may be defined by the first rod 210, the second rod 220, a first connecting portion 231, and a second connecting portion 241. The slit 204 may be open in the horizontal direction. The slit 204 may be provided in pair on opposite sides of the second rod 220. The slit 204 may be elongated vertically.

An upper end of the first rod 210 and an upper end of the second rod 220 may be connected by the first connecting portion 231. The first connecting portion 231 may have a cylindrical shape. A lower end of the first rod 210 and a lower end of the second rod 220 may be connected by the second connecting portion 241.

A first stopper 211 may protrude outward from the outer surface of the first rod 210. The first stopper 211 may protrude in the thickness direction of the second rod 220. A second stopper 213 may protrude outward from the outer surface of the first rod 210. The second stopper 213 may protrude in the thickness direction of the second rod 220. The first stopper 211 may be spaced upward from the second stopper 213 by a predetermined distance. The first stopper 211 and/or the second stopper 213 may be formed on each of the pair of first rods 210. Wings 212 may extend to opposite sides from the first stopper 211. The first stopper 211 may protrude further than the wing 212. The wing 212 may have a plate shape.

A third stopper 221 may protrude from the second rod 220 toward the first rod 210. The third stopper 221 may be formed on a surface of the second rod 220 that faces the first rod 210. The third stopper 221 may be provided on each of opposite surfaces of the second rod 210. The third stopper 221 may be elongated in the horizontal direction along the surface of the second rod 220. The third stopper 221 may be disposed above the first stopper 211.

A fourth stopper 223 may protrude from the second rod 220 toward the first rod 210. The fourth stopper 223 may be formed on a surface of the second rod 220 that faces the first rod 210. The fourth stopper 223 may be provided on each of opposite surfaces of the second rod 210. The fourth stopper 223 may be elongated in the horizontal direction along the surface of the second rod 220. The third stopper 221 may be spaced upward from the fourth stopper 223 by a predetermined distance.

A reinforcing rod 225 may protrude from the second rod 220 toward the first rod 210 in the thickness direction of the second rod 220. The reinforcing rod 225 may be provided on each of opposite surfaces of the second rod 220. The reinforcing rod 225 may be elongated in a longitudinal direction or the vertical direction along the surface of the second rod 220. The reinforcing rod 225 may be provided at a center of the second rod 220. The reinforcing rod 225 may be connected to the third stopper 221 and the fourth stopper 223. The third stopper 221 may protrude to opposite sides from the reinforcing rod 225. The fourth stopper 223 may extend to opposite sides from the reinforcing rod 225 in the longitudinal direction. The reinforcing rod 225 may reinforce the rigidity of the second rod 220.

A first rod head 232 may be formed at an upper end of the rod 200. The first rod head 232 may be formed above the first connecting portion 231. The first rod head 232 may have a cylindrical shape. An outer circumferential surface of the first rod head 232 and an outer circumferential surface of the first connecting portion 231 may be vertically aligned with each other, and may be positioned on the same plane. A portion between the first rod head 232 and the first connecting portion 231 may be recessed inward to define a depressed portion 233. The depressed portion 233 may extend in a circumferential direction of the rod 200.

A second rod head 242 may be formed at a lower end of the rod 200. The second rod head 242 may be formed below the second connecting portion 241. The second rod head 242 may have a cylindrical shape. A disc (or disk) 243 may be provided between the second connecting portion 241 and the second rod head 242. An outer circumferential surface of the disc 243 may have a cylindrical shape extending in the circumferential direction. The outer circumferential surface of the disc 243 may protrude further radially outward than the second rod head 242.

The first blade 310 may be fixed to a top of the rod 200. The first blade 310 may be coupled to the first rod head 232. The first blade 310 may have a tip shape that tapers upward.

The first blade 310 may include a first blade body 311 and a first blade chamfer 312. The first blade body 311 may have a circular cross section. The first blade chamfer 312 may define an inclined surface at an upper end of the first blade body 311. The first blade chamfer 312 may be formed by cutting an upper surface of the first blade body 311 obliquely. The first blade chamfer 312 may be provided in pair.

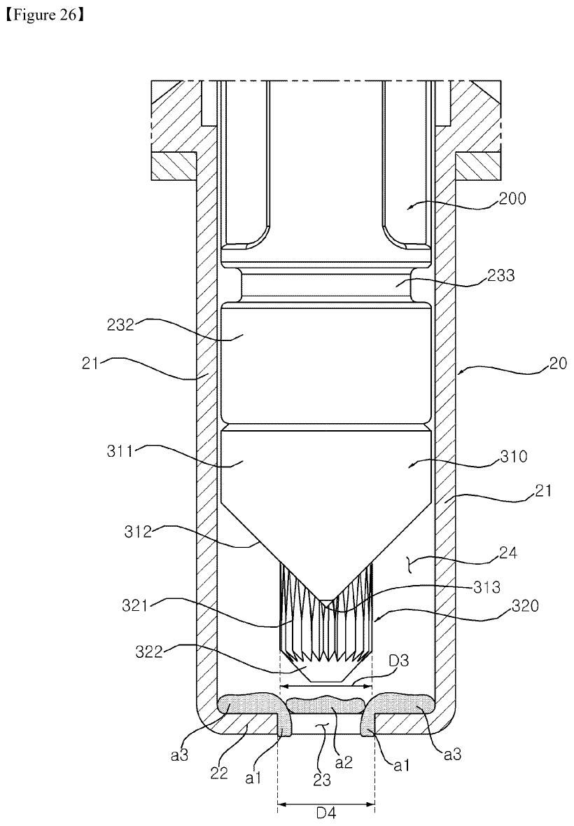

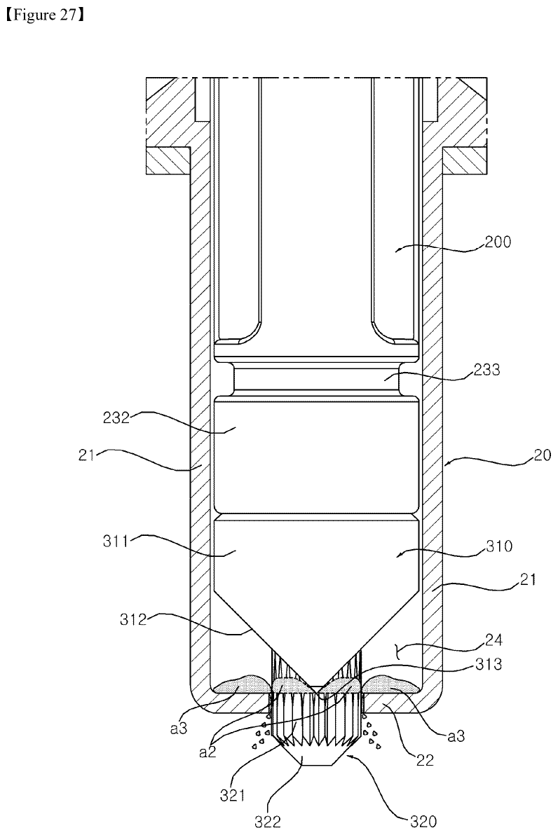

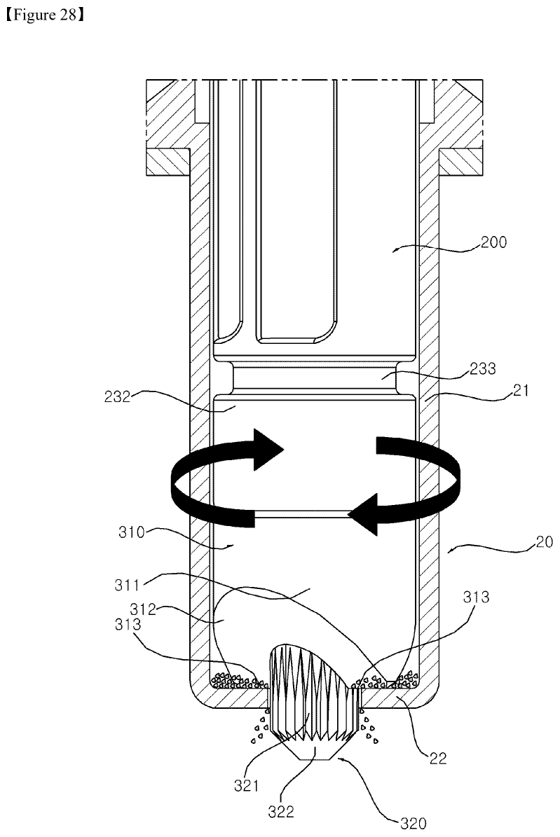

The first blade 310 may include a first blade edge 313. The first blade edge 313 may define an edge at an end of the first blade 310. The pair of first blade chamfers 312 may meet each other at the first blade edge 313. The pair of first blade chamfers 312 may extend obliquely downward from the first blade edge 313 to opposite sides. The first blade edge 313 may extend in the horizontal direction. The first blade 310 may be made of a metal material. The first blade 310 may be inserted into the second insertion space 24 (see FIGS. 26 to 28).

The pin 320 may protrude upward from the first blade 310. The pin 320 may protrude from a center of an upper end of the first blade 310. The pin 320 may include a pin blade 321. The pin 320 may include a pin tip 322. The pin tip 322 may protrude upward from an upper end of the pin blade 321. The pin blade 321 may protrude outward from the upper end of the first blade 310. The pin blade 321 may have a concave and convex portion on its outer circumferential surface. For example, the outer circumferential surface of the pin blade 321 may have a serration shape or a spiral shape. The pin tip 322 may taper upward. The pin tip 322 may have a truncated cone shape. The pin 320 may be made of a metal material. The pin blade 321 and the pin tip 322 may pass through the through-hole 23 (see FIGS. 26 to 28).

The second blade 330 may be fixed to a bottom of the rod 200. The second blade 330 may be coupled to the second rod head 242. The second blade 330 may have a tip shape that tapers downward.

The second blade 330 may include a second blade body 331 and a second blade chamfer 332. The second blade body 331 may have a circular cross section. The second blade chamfer 332 may define an inclined surface at a lower end of the second blade body 331. The second blade chamfer 332 may be formed by cutting a lower surface of the second blade body 331 obliquely. The second blade chamfer 332 may be provided in pair.

The second blade 330 may include a second blade edge 333. The second blade edge 333 may define an edge at an end of the second blade 333. The pair of second blade chamfers 332 may meet each other at the second blade edge 333. The pair of second blade chamfers 332 may extend obliquely upward from the second blade edge 333 to opposite sides. The second blade edge 333 may extend in the horizontal direction. The second blade 330 may be made of a metal material.

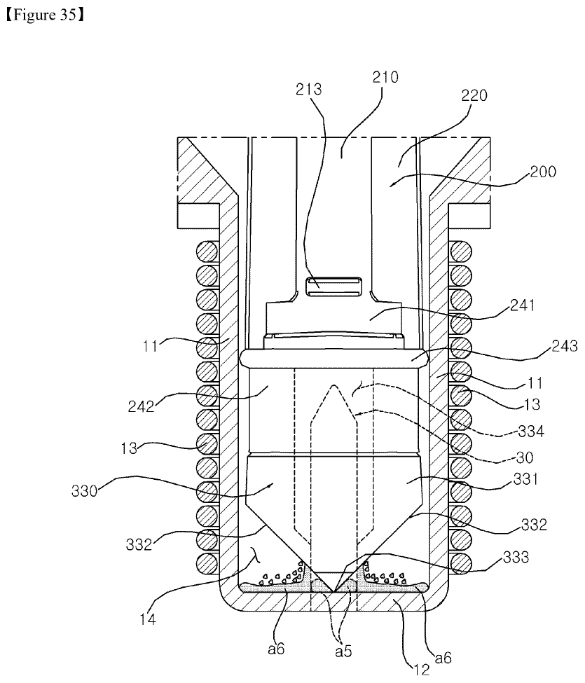

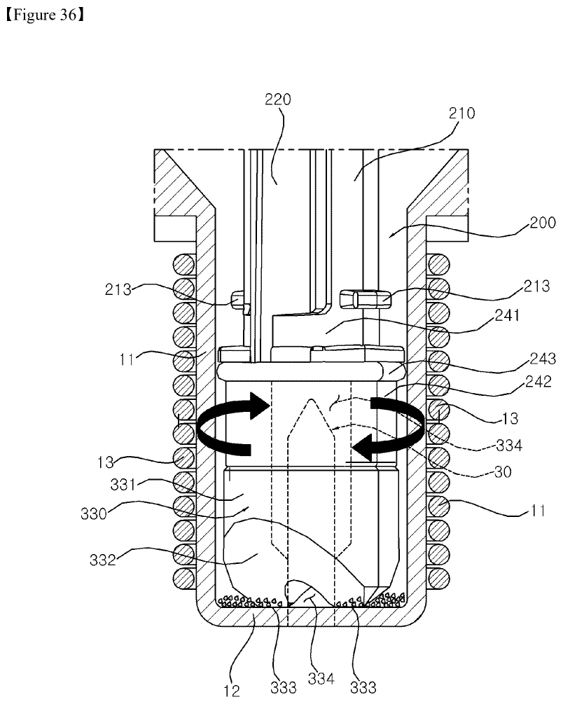

A center of the second blade 330 may be open to define the second blade hole 334. The second blade hole 334 may be formed in a cylindrical shape and may be elongated upward. The second blade 330 may be inserted into the first insertion space 14, and the heater rod 31 may be inserted into the second blade hole 334 (see FIGS. 35 to 37).

A diameter D1 or width D1 of the first blade 310 may be different from a diameter D2 or width D2 of the second blade 330. The diameter D2 of the second blade 330 may be greater than the diameter D1 of the first blade 310. A diameter of the first insertion space 14 may be greater than a diameter of the second insertion space 24. The first blade 310 may be inserted into the second insertion space 24 (see FIG. 1) to clean an inside of the second insertion space 24. The diameter D1 of the first blade 310 may be substantially similar to the diameter of the second insertion space 24. The second blade 330 may be inserted into the first insertion space 14 (see FIG. 1) to clean an inside of the first insertion space 14. The diameter D2 of the second blade 330 may be substantially similar to the diameter of the first insertion space 14.

Each of the pair of first rods 210 may be configured to be bent toward the second rod 220. Accordingly, the first rod 210 and the second rod 220 may come closer to each other. This may allow a width of the slit 204 between the first rod 210 and the second rod 220 to be narrowed. Here, the first stopper 211, the wing 212, and the second stopper 213 that are fixed to the first rod 210 may move toward the second rod 220 together with the first rod 210. The rod 200 may be made of a material having excellent rigidity and elasticity. For example, the rod 200 may be made of plastic.

Referring to FIG. 9, the first blade 310 may include a first blade fixer 315. The first blade fixer 315 may be formed at a lower end of the first blade 310. The first blade fixer 315 may protrude downward from the first blade body 311. The first blade fixer 315 may have a cross section with a non-circular shape. For example, an outer circumferential surface of the first blade fixer 315 may have a serration shape, or a concave-convex shape that causes friction in the circumferential direction. Alternatively, the first blade fixer 315 may have a horizontal-cross section with a triangular shape, a square shape, or the like.

The first rod head 232 may have therein a first blade coupling groove 234 that is open at top. The first blade fixer 315 may be inserted into and fixed to the first blade coupling groove 234. An inner circumferential surface 235 of the first rod head 232 may have a shape corresponding to an outer circumferential surface of the first blade fixer 315. For example, the outer circumferential surface of the first blade fixer 315 and the inner circumferential surface 235 of the first rod head 232 may have serration shapes corresponding to each other, so as to be engaged with each other in the circumferential direction. The outer circumferential surface of the first blade fixer 315 and an outer circumferential surface 235 of the fist blade coupling groove 234 (i.e., the inner circumferential surface 235 of the first rod head 232) may be engaged with each other, thereby preventing circumferential movement of the first blade 310 relative to the rod 200.

The pin 320 may include a pin body 323. The pin body 323 may be elongated vertically. The pin body 323 may extend downward from the pin blade 321. The pin 320 may include a pin fixer 325. The pin fixer 325 may be formed under the pin body 323. The pin fixer 323 may have a cross section with a non-circular shape. For example, an outer circumferential surface of the pin fixer 323 may have a serration shape, or a concave-convex shape that causes friction in the circumferential direction. Alternatively, the pin fixer 323 may have a cross section with a triangle shape, a square shape, or the like.

The first blade 310 may have the first blade hole 314 that is open at top. An outer circumferential surface of the first blade hole 314 may have a shape corresponding to an outer circumferential surface of the pin fixer 323. For example, the outer circumferential surface of the pin fixer 323 and an outer circumferential surface of the blade hole 314 may have serration shapes corresponding to each other, so as to be engaged with each other in the circumferential direction. As the outer circumferential surfaces of the pin fixer 325 and the first blade hole 314 are engaged with each other, circumferential movement of the pin 320 relative to the rod 200 may be prevented.

Accordingly, when rotating the cleaning kit in the circumferential direction (see FIG. 26), rotation of the first blade 310 and/or the pin 320 in the circumferential direction relative to the rod 200 may be prevented, thereby fixing the first blade 310 and/or the pin 320.

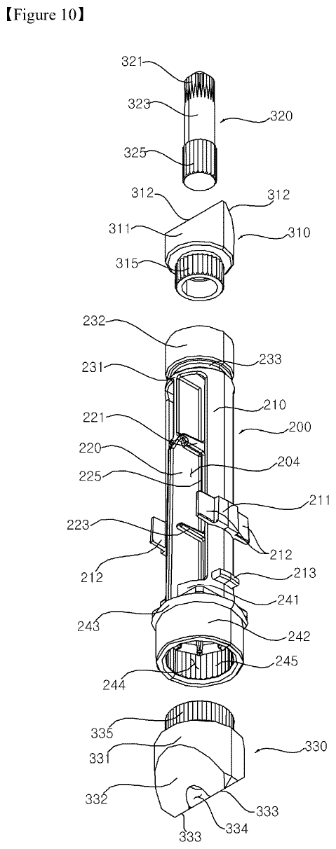

Referring to FIG. 10, the second blade 330 may include a second blade fixer 335. The second blade fixer 335 may be formed at an upper end of the second blade 330. The second blade fixer 335 may protrude upward from the second blade body 331. The second blade fixer 335 may have a cross section with a non-circular shape. For example, an outer circumferential surface of the second blade fixer 335 may have a serration shape, or a concave-convex shape that causes friction in the circumferential direction. Alternatively, the second blade fixer 335 may have a cross section with a triangular shape, a square shape, or the like.

The second rod head 242 may have therein a second blade coupling groove 244 that is open at bottom. The second blade fixer 335 may be inserted into and fixed to the second blade coupling groove 244. An inner circumferential surface 245 of the second rod head 242 may have a shape corresponding to an outer circumferential surface of the second blade fixer 335. For example, the outer circumferential surface of the second blade fixer 335 and the inner circumferential surface 245 of the second rod head 242 may have serration shapes corresponding to each other, so as to be engaged with each other in the circumferential direction. The outer circumferential surface of the second blade fixer 335 and an outer circumferential surface 245 of the second blade coupling groove 244 (i.e., the inner circumferential surface 245 of the second rod head 242) may be engaged with each other, thereby preventing circumferential movement of the second blade 330 relative to the rod 200.

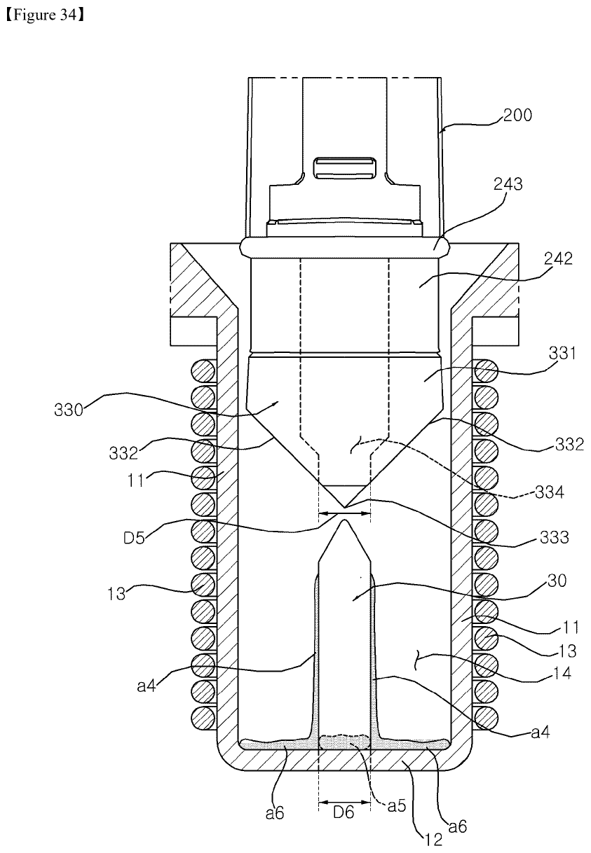

Accordingly, when rotating the cleaning kit in the circumferential direction (see FIG. 34), rotation of the second blade 330 in the circumferential direction relative to the rod 200 may be prevented, thereby fixing the second blade 330.

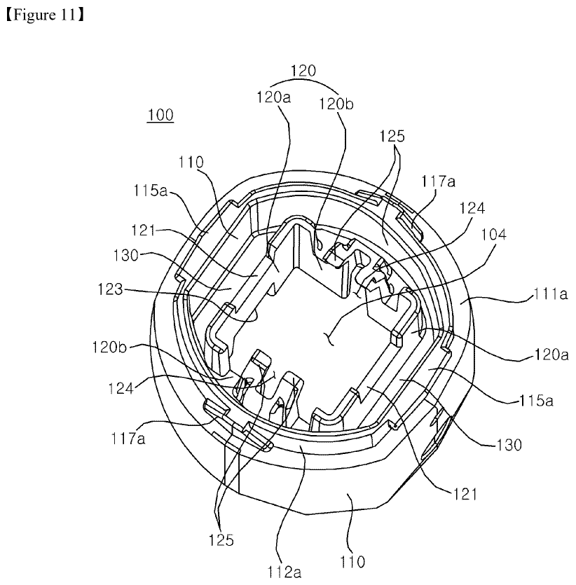

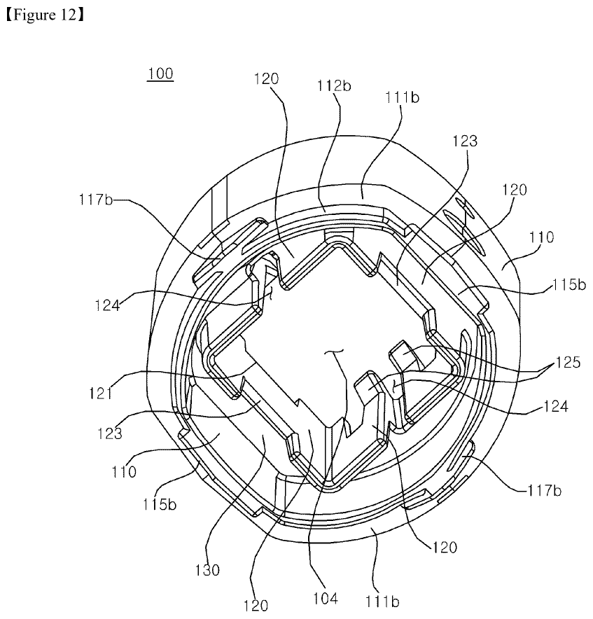

Referring to FIGS. 11 and 12, the frame 100 may have a hollow shape with a rod hole 104. An inner wall 120 of the frame 100 may surround a periphery of the rod hole 104. The rod hole 104 may be open at a top and a bottom of the frame 100. The rod 200 may vertically pass through the rod hole 104. The first recessed portion 112a and the second recessed portion 112b may be formed on an outer wall 110 of the frame 100. The inner wall 120 of the frame 100 may be positioned inward relative to the outer wall 110. A bridge 130 may be disposed between the inner wall 120 and the outer wall 110 of the frame 100, so as to connect the inner wall 120 and the outer wall 110.

The inner wall 120 of the frame 120 may include a first inner wall 120a and a second inner wall 120b. A pair of first inner walls 120a and a pair of second inner walls 120b may define the rod hole 104. The pair of first inner walls 120a may be disposed at opposite sides with respect to the rod hole 104 so as to face each other. The pair of second inner walls 120b may be disposed on opposite sides with respect to the rod hole 104 so as to face each other. Opposite ends of the first inner wall 120a may be connected to respective ends of the pair of second inner walls 120b. Opposite ends of the second inner wall 120b may be connected to respective ends of the pair of first inner walls 120a. The first inner wall 120a and the second inner wall 120b may be alternately arranged in the circumferential direction.

The frame 100 may include a first engaging portion 121. The first engaging portion 121 may be formed on the first inner wall 120a of the frame 100. An upper end of the first inner wall 120a of the frame 100 may be recessed downward to define the first engaging portion 121. A pair of first engaging portions 121 may be disposed opposite each other with respect to the rod hole 104.

The frame 100 may include a second engaging portion 123. The second engaging portion 123 may be formed on the first inner wall 120a of the frame 100. A lower end of the first inner wall 120a of the frame 100 may be recessed upward to define the second engaging portion 123. A pair of second engaging portions 123 may be disposed opposite each other with respect to the rod hole 104. The second engaging portion 123 may be formed at a position corresponding to the first engaging portion 121 in the vertical direction. The second engaging portion 123 may be positioned below the first engaging portion 121. The first engaging portion 121 and the second engaging portion 123 may be vertically spaced apart from each other by a predetermined distance. A separation distance between the first stopper 121 and the second stopper 123 may be equal or similar to a separation distance between the first stopper 211 and the second stopper 213.

The frame 100 may include a slide groove 124. The second inner wall 120b of the frame 100 may be recessed outward from the rod hole 104 to define the slide groove 124. The slide groove 124 may be elongated vertically. The slide groove 124 may communicate with the rod hole 104. A pair of slide grooves 124 may be disposed opposite each other with respect to the rod hole 104.

The frame 100 may include a third engaging portion 125. The third engaging portion 125 may be formed adjacent to an upper side of the slide groove 124. The third engaging portion 125 may be bent from an upper end of the second inner wall 120b toward the rod hole 104. The third engaging portion 125 may protrude toward the rod hole 104. A pair of third engaging portions 125 may be disposed on opposite sides with the slide groove 124 interposed therebetween. The pair of third engaging portions 125 may be located opposite each other with respect to the rod hole 104 to thereby face each other.

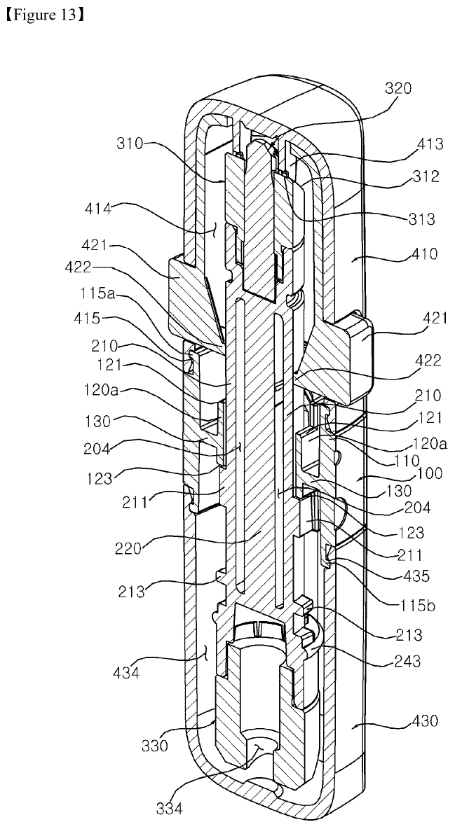

Referring to FIGS. 13 to 15, the rod 200 may be coupled to or supported by the frame 100. The rod 200 may pass through the rod hole 104 of the frame 100 so as to protrude up and down from the frame 100. A portion of a circumference of the rod 200 may be surrounded by the inner wall 120 of the frame 100. The rod 200 may be supported by the inner wall 120 of the frame 100. The first cap 410 and/or the second cap 430 may be coupled to the frame 100. An upper end of the rod 200 may be disposed inside the first cap 410. A lower end of the rod 200 may be disposed inside the second cap 430.

An edge of the second rod 220 may be inserted into the slide groove 124. The edge of the second rod 220 may be supported by the second inner wall 120b of the frame 100 in the slide groove 124. The slide groove 124 and the second rod 220 may be elongated in the vertical direction or the longitudinal direction.

The rod 200 may be located in a first position with respect to the frame 100. The first position may be a state before the rod 200 is moved from the frame 100.

Referring to FIG. 13, an outer surface of the first rod 210 may be supported by an inner surface of the first inner wall 120a of the frame 100. The first stopper 211 may be supported by the second engaging portion 123. The first stopper 211 may be disposed under the second engaging portion 123. The wing 212 (see FIG. 7) may be supported by the inner surface of the first inner wall 120a.

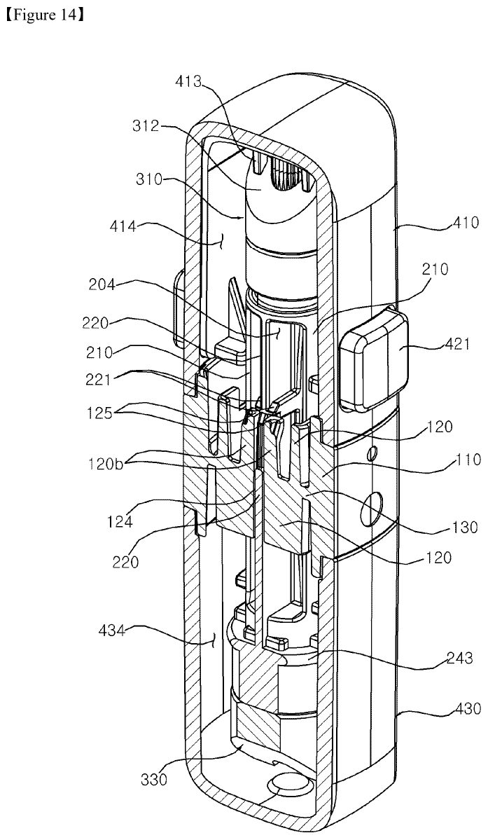

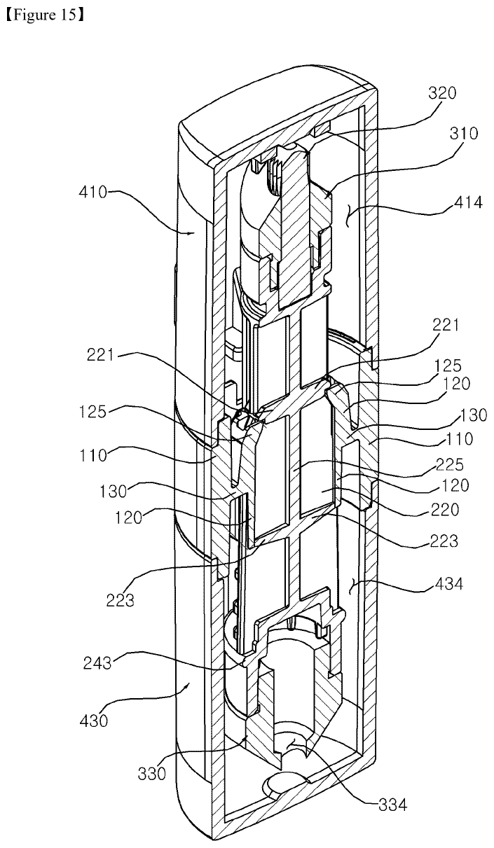

Referring to FIGS. 14 and 15, opposite ends of the third stopper 221 may be supported by the third engaging portions 125 at opposite sides. The third stopper 221 may be disposed on the third engaging portion 125. The third engaging portions 125 may support opposite surfaces of the rod 200. Opposite ends of the fourth stopper 223 may be supported by an inner surface of the second inner wall 120b of the frame 100.

Accordingly, the frame 100 may support a bottom of the third stopper 221 and a top of the first stopper 211, allowing the rod 200 to be fixed in the longitudinal direction with respect to the frame 100. Also, the frame 100 may surround and support the rod 200, thereby fixing the rod 200 in the transvers direction with respect to the frame 100.

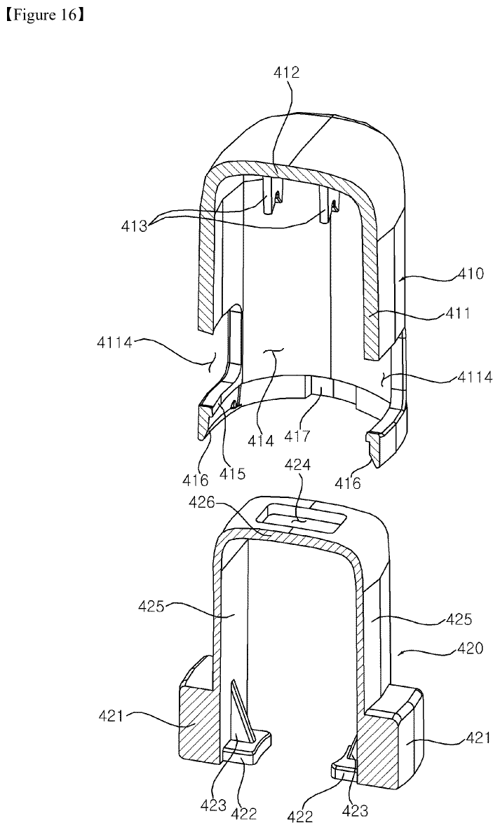

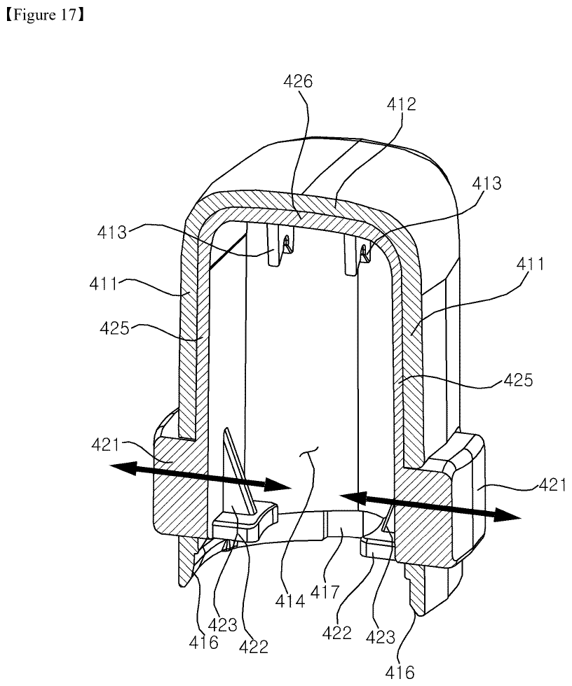

Referring to FIGS. 16 and 17, the first cap 410 may include a lateral wall 411 and an upper wall 412. A periphery of the first chamber 414 may be surrounded by the lateral wall 411 of the first cap 410. An upper portion of the first chamber 414 may be covered by the upper wall 412 of the first cap 410. A lower portion of the first chamber 414 may be open.

The lateral wall 411 of the first cap 410 may be open to define a pusher hole 4114. The pusher hole 4114 may communicate with the first chamber 414. A pair of pusher holes 4114 may be disposed opposite each other with respect to the first chamber 414 to thereby face each other.

A positioning portion 413 may protrude downward from an inner surface of the upper wall 412 of the first cap 410 toward the first chamber 414. The positioning portion 413 may be disposed in the vicinity of a center of the upper wall 412. A pair of positioning portions 413 may be disposed opposite each other with respect to the center. The pair of positioning portions 413 may be vertically aligned with a position of the first blade 310. A lower surface of the positioning portion 413 may be recessed upward. The lower surface of the positioning portion 413 may have a shape corresponding to an upper surface of the first blade 310. The lower surface of the positioning portion 413 may be inclined so as to correspond to an upper end of the first blade 310.

A pusher assembly 420 may include a first pusher 421 and a second pusher 422. The pusher assembly 420 may include a first pusher bar 425. The pusher assembly 420 may include a second pusher bar 426.

A pair of first pusher bars 425 may be elongated vertically. The pair of first pusher bars 425 may be spaced apart from each other by a predetermined distance, so as to be arranged parallel to each other. The second pusher bar 426 may be disposed between the pair of first pusher bars 425. The second pusher bar 426 may connect upper ends of the pair of first pusher bars 425. The second pusher bar 426 may be elongated in the horizontal direction. The first pusher bar 425 may extend downward from an end of the second pusher bar 426.

The first pusher 421 may be adjacent to a lower end of the first pusher bar 425. The first pusher 421 may protrude from an outer surface of the first pusher bar 425 to an outside of the pusher assembly 420.

The second pusher 422 may be disposed at a position corresponding to the first pusher 421. The first pusher 422 may be adjacent to the lower end of the first pusher bar 425. The first pusher bar 425 may be disposed between the first pusher 421 and the second pusher 422. The second pusher 422 may be disposed opposite the first pusher 422 with respect to the first pusher bar 425. The second pusher 422 may be adjacent to an end of the first pusher bar 425. The second pusher 422 may protrude from an inner surface of the first pusher bar 425 to an inside of the pusher assembly 420. An inner surface of the second pusher 422 may be curved. The inner surface of the second pusher 422 may be inwardly recessed. The inner surface of the second pusher 422 may correspond to a curved outer circumferential surface of the first rod 210. The inner surface of the second pusher 422 may come into close contact with one side of the outer circumferential surface of the first rod 210 in a covered manner.

A rib 423 may protrude inward from the inner surface of the first pusher bar 425. The rib 423 may be disposed at a position corresponding to the first pusher 421. The rib 423 may extend from the inner surface of the first pusher bar 425 up to the second pusher 422. The rib 423 may support the second pusher 422. The rib 423 may reinforce the rigidity of the second pusher 422. The rib 423 may be inclined such that a width thereof gradually decreases upward.

The second pusher bar 426 may be open to define a slot 424. The slot 424 may be elongated in a longitudinal direction of the second pusher bar 426. The slot 424 may be formed at a position corresponding to the positioning portion 413.

The pusher assembly 420 may be inserted into the first chamber 414 that defines an inside of the first cap 410. The first pusher 421 may pass through the pusher hole 4114 so as to protrude out of the first cap 410. The second pusher 422 may protrude to the first chamber 414. The positioning portion 413 may pass through the slot 424 to protrude below the slot 424.

The pusher assembly 420 may be supported by the first cap 410. The outer surface of the first pusher bar 425 may be supported by an inner surface of the lateral wall 411 of the first cap 410. The first pusher bar 425 may extend long, up to the upper wall 412 of the first cap 410, along the lateral wall 411 of the first cap 410. An upper surface of the second pusher bar 426 may be supported by a lower surface of the upper wall 412 of the first cap 410. The second pusher bar 426 may be fixed to the first cap 410.

The pusher assembly 420 may be made of a material having excellent elasticity and rigidity. For example, the pusher assembly 420 may be made of plastic. The pusher assembly 420 may have a restoring force. The first pusher 421 may move horizontally in the pusher hole 4114. When the first pusher 421 is pressed toward the inside of the first cap 410, the first pusher bar 425 may be tilted to the inside of the first cap 410 with respect to the second pusher bar 426. The first pusher 421 and the second pusher 422 may move inward of the first cap 410 together with the first pusher bar 425. A gap between the pair of second pushers 422 may be narrowed. When the first pusher 421 is not pressed, the first pusher bar 425 may be tilted to an outside of the first cap 410 with respect to the second pusher bar 426, causing the first pusher 421 and the second pusher 422 to be restored to their original positions.

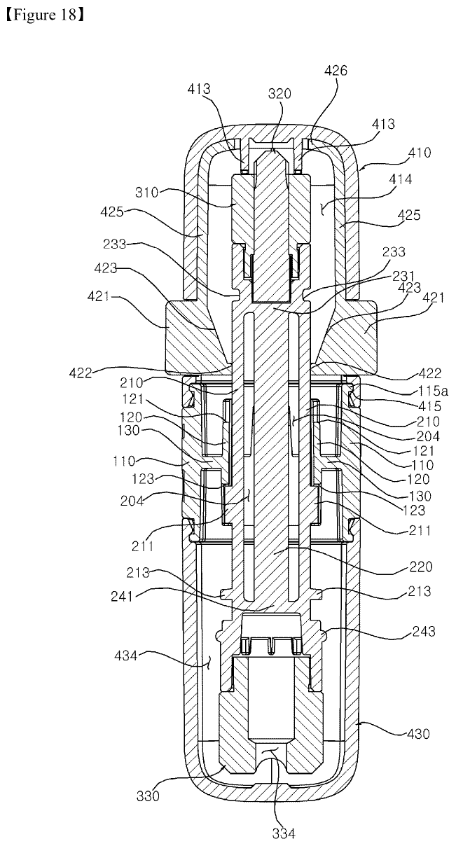

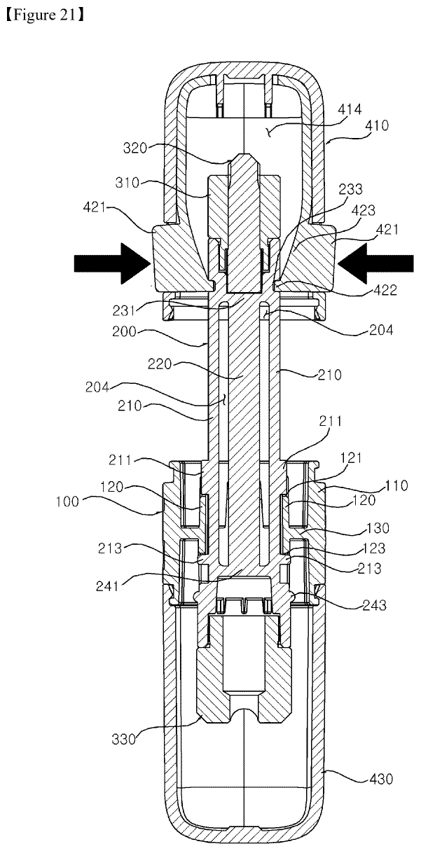

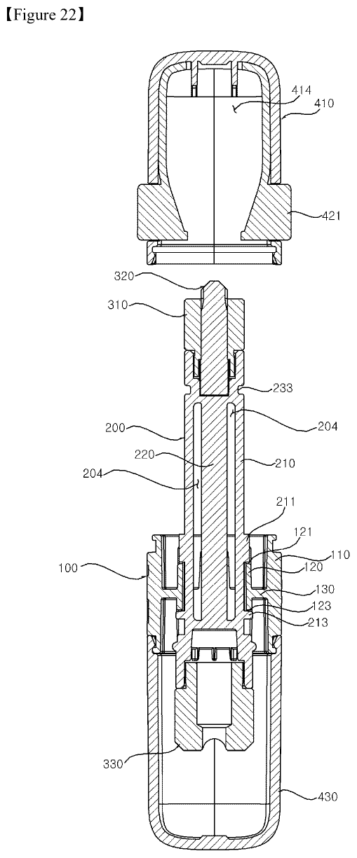

Referring to FIGS. 18 to 22, the rod 200 may be movably coupled to the frame 100. The rod 200 may move in its longitudinal direction with respect to the frame 100. The rod 200 may be elongated in the vertical direction, and the rod 200 may move up and down with respect to the frame 100. The rod 200 may move upward with respect to the frame 100, from a first position (see FIG. 18) to a second position (see FIGS. 21 and 22). The method in which the rod 200 is movably coupled to the frame 100 in the longitudinal direction of the rod 200 with respect to the frame 100 may vary. The following description is merely an example, and the movement method of the rod 200 is not limited thereto.

In the first position, the first stopper 211 may be supported by the second engaging portion 123 to thereby fix the rod 200. In the second position, the first stopper 211 may be supported by the first engaging portion 121, and the second stopper 213 may be supported by the second engaging portion 123, thereby fixing the rod 200. This may allow the first blade 310 and the pin 320 to be in a usable state.

A height H2 from a bottom of the second insertion space 24 to the insertion hole 44 may be greater than a height H1 of the first insertion space 14 (see FIG. 2). As such, by moving the rod 200 to the second position, an upper portion of the rod 200 may protrude further upward from the frame 100, so as to allow the cleaning kit to be changed in shape suitable for cleaning the second insertion space 24. In addition, the cleaning kit may be manufactured in a compact size.

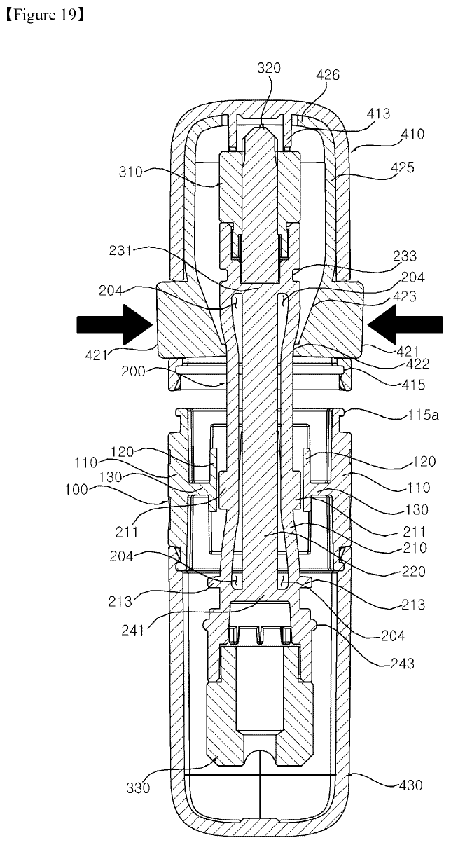

Referring to FIGS. 18 and 19, when the first pusher 421 is pressed, the first pusher bar 425 may be tilted to an inside of the first cap 410 with respect to the second pusher bar 426, allowing the first pusher 421 and the second pusher 422 to be moved inward of the first cap 410.

Accordingly, the pair of second pushers 422 may respectively press the pair of first rods 210 toward the second rod 220. With respect to the first connecting portion 231 and the second connecting portion 241, the pair of first rods 210 may be configured to be bent in a thickness direction of the first rod 210 toward the second rod 220. The first rod 210 may be bent inwardly. This may allow a width of the slit 204 to be narrowed.

The first stopper 211, together with the first rod 210, may move toward the second rod 220. A width between the pair of first rods 210 may be narrowed. A width between a pair of first stoppers 211 may be narrowed.

The first stopper 211 may move further inward relative to the second engaging portion 123 and the first inner wall 120a of the frame 100. The first stopper 211 may be in a state released from the second engaging portion 123.

Accordingly, the first cap 410 may be removed upward from the frame 100, and simultaneously, the rod 200 in the first position may be moved upward by picking up or holding the rod 200 through the pusher assembly 420. The first coupling protrusion 115a may be separated from the first coupling groove 415. The first stopper 211 may be supported on an inside of the first inner wall 120a and may slide upward.

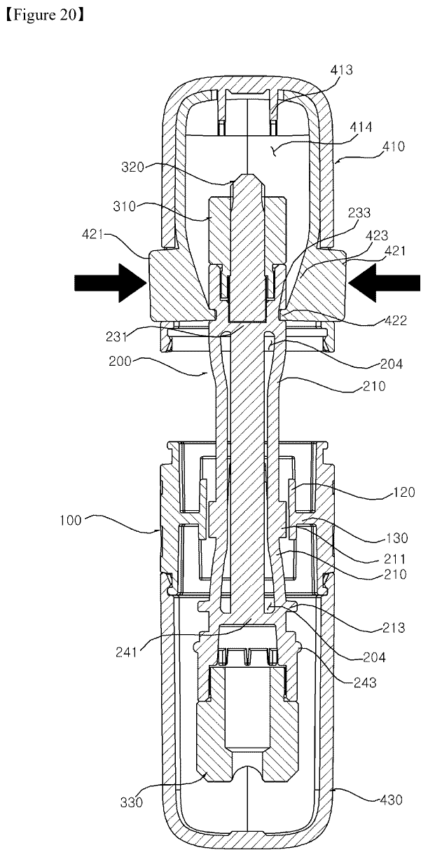

Referring to FIGS. 19 and 20, when the first cap 410 is moved upward while reducing force of pressing the first pusher 421, the first cap 410 may move upward with respect to the rod 200. Here, the second pusher 422 may support the first rod 210 and slide upward along the first rod 210, allowing the first cap 410 to move while being aligned with respect to the rod 200. When the first cap 410 is moved upward while reducing the force of pressing the first pusher 421, the second pusher 422 may be inserted into and engaged with the depressed portion 233 while moving.

Referring to FIGS. 20 and 21, when the second pusher 422 is inserted into and engaged with the depressed portion 233, the pusher assembly 420 may not receive resistance from a restoring force of the first rod 210. Accordingly, the rod 200 may be moved upward with respect to the frame 100 with a relatively reduced force of pressing the first pusher 421. Alternatively, the rod 200 may be moved upward, while the second pusher 422 is not inserted into the depressed portion 233, by pressing the first pusher 421 with the same force.

When the rod 200 is moved by a predetermined distance to reach the second position, the bent first rod 210 may be restored to a state parallel to the second rod 220. The first stopper 211 may be engaged with the first engaging portion 121. The second stopper 213 may be engaged with the second engaging portion 123. An outer circumferential surface of the first rod 210 between the first stopper 211 and the second stopper 213 may be supported by the first inner surface 120a of the frame 100.

Accordingly, in the second position, the rod 200 may be fixed in position with respect to the frame 100.

Referring to FIGS. 21 and 22, when the first pusher 421 is not pressed, the second pusher 422 that is inserted into the depressed portion 233 may be separated from the depressed portion 233. Accordingly, while the rod 200 is located in the second position, the first cap 410 may be removed from the rod 200, and the first blade 310 and the pin 320 may be exposed to the outside.

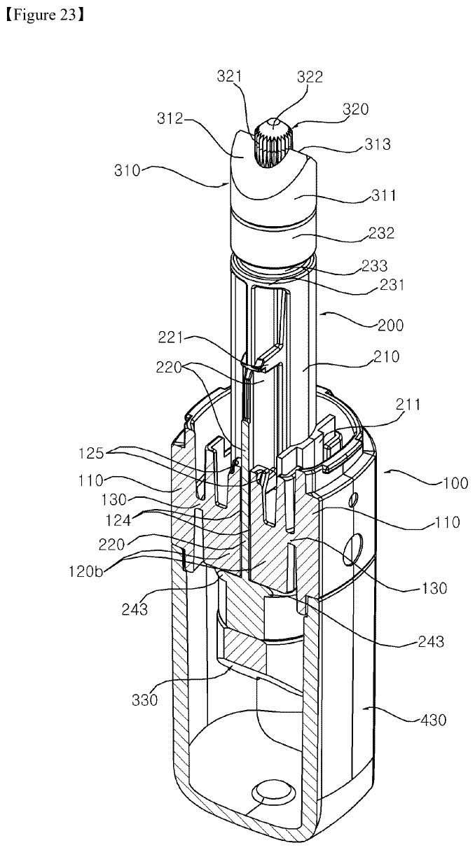

Referring to FIGS. 14 and 23, when the rod 200 moves from the first position to the second position, the second rod 220 may slide upward on the slide groove 124. The third stopper 221 may be separated upward from the third engaging portion 125. As the rod 200 moves, the second rod 220 may be supported by the second inner wall 120b and the third engaging portion 125 of the frame 100. Accordingly, the rod 200 may be moved in a stable manner. In the second position, the disc 243 may be engaged with and supported by a lower end of the inner wall 120 of the frame 100. Thus, upward movement of the rod 200 may be limited or inhibited.

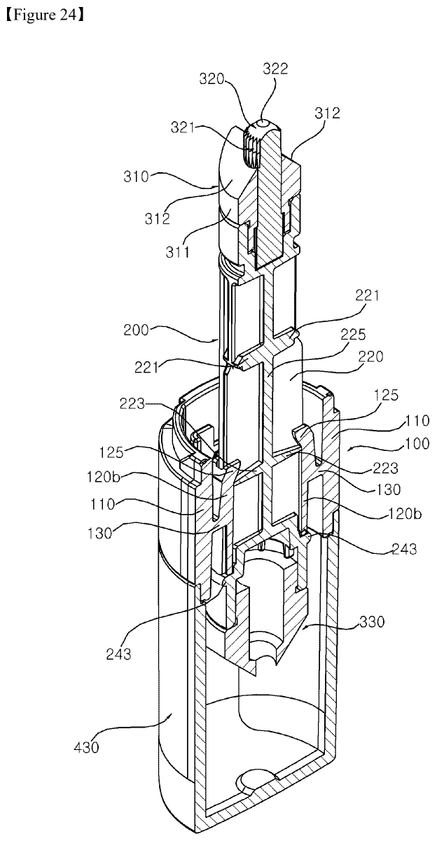

Referring to FIGS. 15 and 24, the fourth stopper 223 may be supported by the second inner wall 120b of the frame 100. When the rod 200 moves from the first position to the second position, the fourth stopper 223 may be supported by the second inner wall 120b of the frame 100 and may slide upward. Accordingly, the rod 200 may be moved in a stable manner.

In the first position, the third stopper 221 may be supported by an upper portion of the third engaging portion 125. In the second position, the third stopper 221 may be separated from the third engaging portion 125, and the fourth stopper 223 may be engaged with and supported by a lower portion of the third engaging portion 125. Thus, upward movement of the rod 200 may be limited or inhibited.

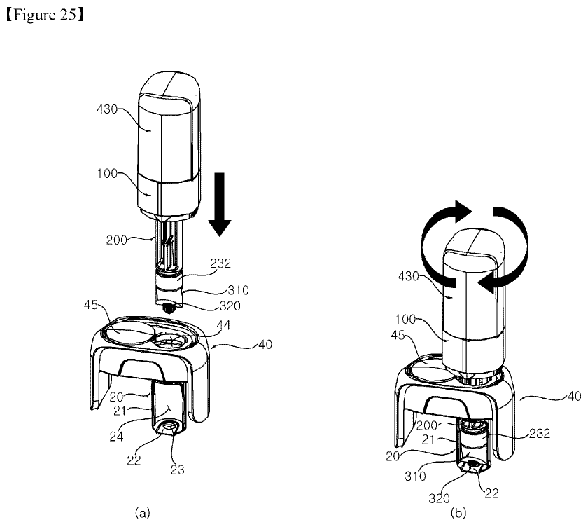

Referring to FIG. 25, in a state where the first cap 410 is removed from the frame 100, the rod 200 located in the second position, the first blade 310, and the pin 320 may be be inserted into the second insertion space 24 of the extractor 20.

A length from an upper end of the frame 100 to an end of the first blade 310 may be equal to or greater than the height H2 (see FIG. 2) from the bottom of the second insertion space 24 to the insertion hole 44. The upper end of the frame 100 may be spaced apart from the upper case 40 while the first blade 310 and an upper portion of the rod 200 are inserted into the second insertion space 24. The end of the first blade 310 may come into contact with the second flange 22 of the extractor 20. The pin 320 may be inserted into the through-hole 23. An outer circumferential surface of the rod 200 and the second insertion space 24 may have cylindrical shapes corresponding to each other. The through-hole 23 may have a circular cross section.

Accordingly, a user may rotate the cleaning kit in the circumferential direction while holding the frame 100 and/or the second cap 430, so as to rotate the first blade 310 and the pin 320 in the second insertion space 24, allowing the extractor 20 to be cleaned.

Referring to FIGS. 26 to 28, when the stick S (see FIG. 2) is removed from the second insertion space 24 of the extractor 20 after using the aerosol generating device, residues a1, a2, and a3, which are aerosol residues or residues leaked from the stick S, may accumulate in the extractor 20. These residues a1, a2, and a3 sticking to the extractor 20 at a high temperature may cool down and harden into a solid, making them difficult to remove from the extractor 20.

The first blade 310 may be inserted into the second insertion space 24 so as to move toward the second flange 22. The first blade edge 313 may come into contact with the second flange 22. The pin 320 may pass through the through-hole 23. The first blade 310 and the pin 320 may remove the residues a1, a2, and a3 sticking to the extractor 20. The first blade 310 and the pin 320 may be made of a metal having higher rigidity than the residues a1, a2, and a3 in the solid state.

When the pin 320 passes through the through-hole 23, a first residue a1 sticking around the through-hole 23 may be removed. Here, a remaining first residue a1 may be scraped off as the pin blade 321 rotates in the circumferential direction in the through-hole 23, thereby removing the remaining first residue a1. A maximum diameter D3 of the pin blade 321 may be equal or similar to a diameter D4 of the through-hole 23. As the pin tip 322 is formed obliquely, namely, in a chamfered shape, although the diameter D4 of the through-hole 23 is narrowed by the first residue a1, the pin tip 322 may easily pass through the through-hole 23 to thereby remove the first residue a1.

The first blade 310 may move toward the second flange 22, and then may collide with a second residue a2 and a third residue a3 sticking to an upper surface of the second flange 22. The first blade edge 313 may collide with the second residue a2 and the third residue a3 to thereby decompose the second residue a2 and the third residue a3. The second residue a2 and the third residue a3 may be decomposed into smaller pieces by repeating the above process. The first blade 310 positioned in the second insertion space 24 may be rotated in the circumferential direction while being adjacent to or in contact with the second flange 22, so as to scrape off the undecomposed second residue a2 and third residue a3. Accordingly, the second residue a2 and the third residue a3 may be easily removed.

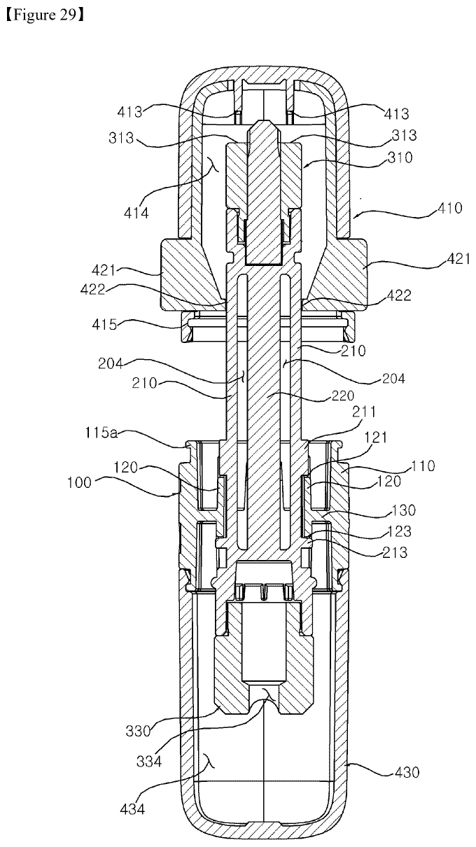

Referring to FIGS. 29 to 32, the first cap 410 may push the rod 200 to the first position when being coupled to the frame 100 again, so that the second cap 430 may be removed from the frame 100. This may allow the second blade 330 to be in a usable state.

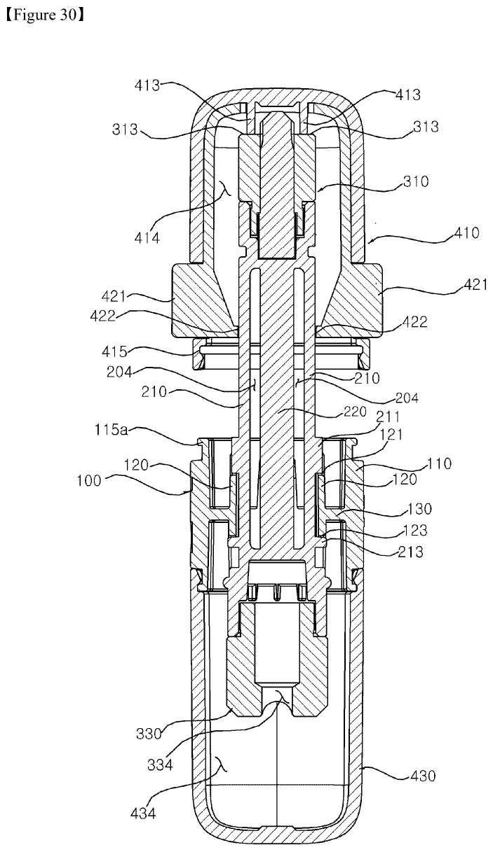

Referring to FIGS. 29 and 30, while the rod 200 is located in the second position, the first blade 310 and the pin 320 may be inserted into the first chamber 414 inside the first cap 410. Here, a lower surface of the positioning portion 413 may come into contact with the first blade chamfer 312 (see FIG. 23). The lower surface of the positioning portion 413 may have a slope substantially corresponding to that of the pair of first blade chamfers 312. The lower surface of the positioning portion 413 may come into contact with the first blade chamfer 312, so as to guide the positioning portion 413 to be aligned to the first blade chamfer 312.

Accordingly, the first cap 410 may be aligned in place with respect to the frame 100. Here, the pair of second pushers 422 may come into contact with outer circumferential surfaces of the pair of first rods 210, respectively. In addition, positions of the first coupling protrusion 115a and the first coupling groove 415 may be vertically aligned with each other. Also, positions of the first cap guide 117a and the first guide groove 417 may be vertically aligned with each other.

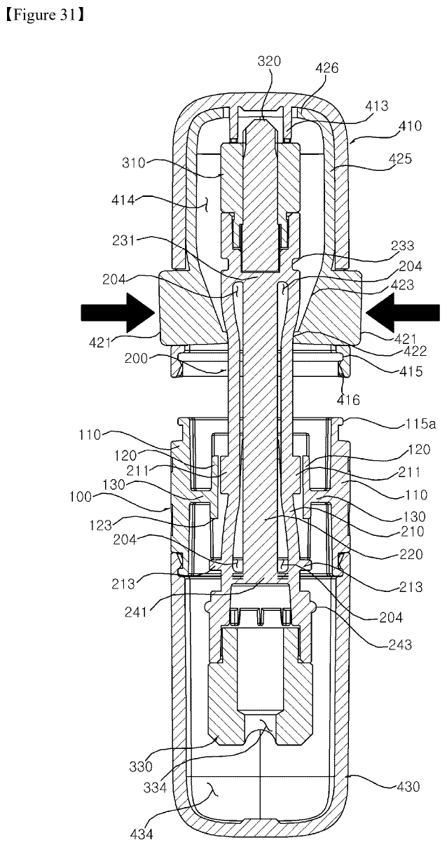

Referring to FIGS. 30 and 31, in a state where the first cap 410 is properly aligned with respect to the frame 100, the first pusher 421 may be pressed inward of the first cap 410. When the first pusher 421 is pressed, the first pusher bar 425 may be tilted to an inside of the first cap 410 with respect to the second pusher bar 426, and the first pusher 421 and the second pusher 422 may be moved to the inside of the first cap 410.

Accordingly, the pair of second pushers 422 may respectively press the pair of first rods 210 toward the second rod 220. With respect to the first connecting portion 231 and the second connecting portion 241, the pair of first rods 210 may be configured to be bent toward the second rod 220 in the thickness direction of the first rod 210. The first rod 210 may be bent inwardly. This may allow a width of the slit 204 to be narrowed.

The first stopper 211, together with the first rod 210, may move toward the second rod 220. A width between the pair of first rods 210 may be narrowed. A width between the pair of first stoppers 211 may be narrowed.

The first stopper 211 may move further inward relative to the first engaging portion 121 and the first inner wall 120a of the frame 100. The first stopper 211 may be in a state released from the first engaging portion 121.

Accordingly, the rod 200 in the second position may be moved downward by pushing the first cap 410 downward. The first stopper 211 may be supported on an inside of the first inner wall 120a and may slide downward.

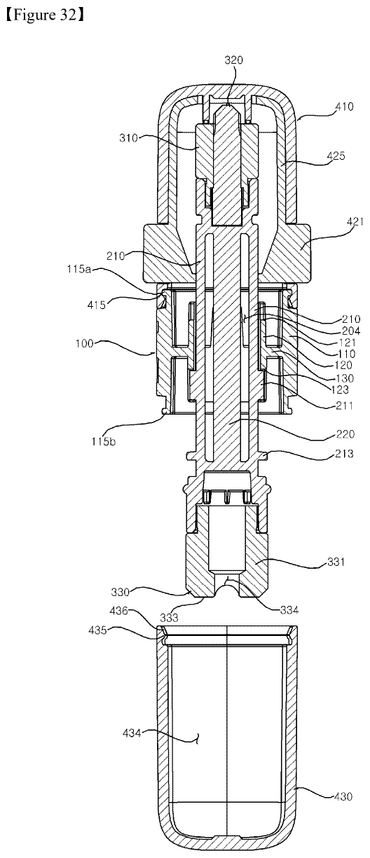

Referring to FIGS. 31 and 32, the rod 200 may be moved to the first position by pushing the first cap 410 downward, and the first cap 410 may be coupled to the frame 100. When the first pusher 421 is not pressed, the first stopper 211 may be engaged with and supported by the second engaging portion 123. The first stopper 211 may be supported by the second engaging portion 123 to thereby limit upward movement of the rod 200. The third stopper 221 (see FIG. 14) may be engaged with and supported by the third engaging portion 125. The third stopper 221 may be supported by the third engaging portion 125 to thereby limit or inhibit downward movement of the rod 200. The first stopper 211 and the third stopper 221 may be supported by the frame 200, allowing the rod 200 to be fixed to the frame 100.

When the second cap 430 is removed from the frame 100 while the rod 200 is located in the first position, the second blade 330 may be exposed to the outside. A lower end of the rod 200 and the second blade 330 may protrude below the frame 100.

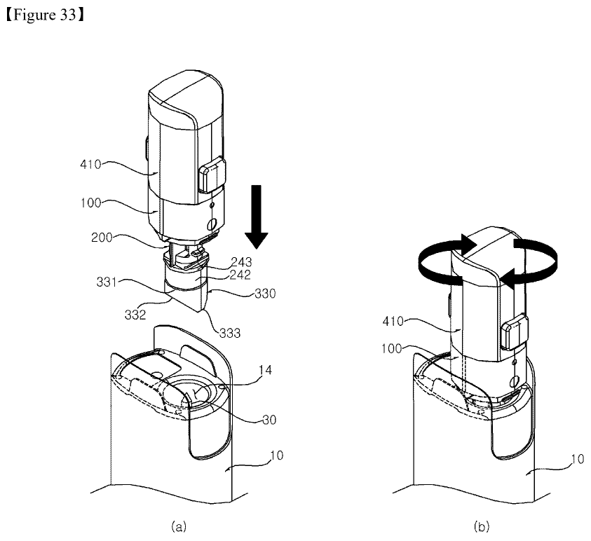

Referring to FIG. 33, in a state where the second cap 430 is removed from the frame 100, the rod 200 located in the first position and the second blade 330 may be inserted into the first insertion space 14.

A length from a lower end of the frame 100 to an end of the second blade 330 may be equal to or greater than the height H1 of the first insertion space 14 (see FIG. 2). In a state where lower portions of the second blade 330 and the rod 200 are inserted into the first insertion space 14, the lower end of the frame 100 may be spaced apart from the body 100.

Accordingly, a user may rotate the cleaning kit in the circumferential direction 14 while holding the frame 100 and/or the first cap 410, so as to rotate the second blade 330 in the first insertion space 14, allowing an inside of the first insertion space 14 to be cleaned.

Referring to FIGS. 34 to 36, when the stick S (see FIG. 2) is removed from the second insertion space 24 after using the aerosol generating device, residues a4, a5, and a6, which are aerosol residues or residues leaked from the stick S, may accumulate in the first insertion space 14. These residues a4, a5, and a6 sticking to the pipe (11, 12) and an outer circumferential surface of the heater assembly 30 at a high temperature may cool down and harden into a solid, making them difficult to remove from the pipe (11, 12) or the heater assembly 30.

The second blade 330 may be inserted into the first insertion space 14 so as to move toward the first flange 12. The second blade edge 333 may come into contact with the first flange 12. The heater assembly 30 may be inserted into the second blade hole 334. The outer circumferential surface of the heater assembly 30 and an outer circumferential surface of the second blade hole 334 (i.e., an inner circumferential surface of the second blade 330) may have shapes corresponding to each other. The second blade 330 may remove the residues a4, a5, and a6 sticking to the pipe (11, 12) and the heater assembly 30. The second blade 330 may be made of a metal having higher rigidity than the residues a4, a5, and a6 in the solid state.

When the heater assembly 30 is inserted into the second blade hole 334, a fourth residue a4 sticking to the outer circumferential surface of the heater assembly 30 may be scraped off by the inner circumferential surface of the second blade 330, thereby removing the fourth residue a4. A diameter D5 of the second blade hole 334 may be equal or similar to a diameter D6 of the heater assembly 30. Here, in order to remove a remaining fourth residue a4 by rotating the cleaning kit, the inner circumferential surface of the second blade 330 may have a concave-convex shape such as a serration shape or the like.

The second blade 330 may move toward the first flange 12, and then may collide with a fifth residue a5 and a sixth residue a6 sticking to an upper surface of the first flange 12. The second blade edge 333 may collide with the fifth residue a5 and the sixth residue a6 to thereby decompose the fifth residue a5 and the sixth residue a6. The fifth residue a5 and the sixth residue a6 may be decomposed into smaller pieces by repeating the above process. The second blade 330 positioned in the first insertion space 14 may be rotated in the circumferential direction while being adjacent to or in contact with the first flange 12, so as to scrape off the undecomposed fifth residue a5 and the sixth residue a6. Accordingly, the fifth residue a5 and the sixth residue a6 may be easily removed.

An outer circumferential surface of the disc 243 may come into contact with an inner circumferential surface of the first lateral wall 11 of the pipe (11, 12). An outer circumferential surface of the second blade 330 may be spaced inward from the inner circumferential surface of the first lateral wall 11.

Accordingly, contact resistance to the second blade 330 may be reduced, allowing the second blade 330 to be rotated easily. In addition, damage to the pipe (11, 12) or the second blade 330 may be reduced.

Referring to FIGS. 1 to 36, a cleaning kit according to an aspect of the present disclosure may include: a rod that is elongated in a longitudinal direction; a first blade protruding from one end of the rod; a second blade protruding from another end of the rod, wherein the second blade is shaped to define a blade hole at an end of the second blade and along the longitudinal direction of the rod; and a pin protruding from an end of the first blade.

According to another aspect of the present disclosure, a width of the first blade may be less than a width of the second blade.

According to another aspect of the present disclosure, the first blade may include: a first blade edge defining an edge at the end of the first blade; and a pair of first blade chamfers inclined obliquely from the first blade edge and extending to opposite sides of the first blade.

According to another aspect of the present disclosure, the second blade may include: a second blade edge defining an edge at the end of the second blade; and a pair of second blade chamfers inclined obliquely from the second blade edge and extending to opposite sides of the second blade.

According to another aspect of the present disclosure, the pin may include a pin blade protruding from a center of the end of the first blade, wherein the pin blade defines an outer circumferential surface of a portion of the pin and includes a repeating concave shape.

According to another aspect of the present disclosure, the pin blade may have a serration shape.

According to another aspect of the present disclosure, the pin may include a pin tip located at an end of the pin, wherein the pin tip includes a tapered protruding shape.

According to another aspect of the present disclosure, the blade hole may have a cylindrical shape.

According to another aspect of the present disclosure, the first blade and the second blade may be coupled to engage with the rod in a circumferential direction, wherein the engage with the rod limits rotation of the first blade and the second blade in the circumferential direction relative to the rod.

According to another aspect of the present disclosure, the pin may be sized to be inserted into the first blade and be coupled to engage with the first blade in the circumferential direction, wherein the engaging pf the pin with the first blade limits rotation of the pin in the circumferential direction relative to the first blade.

According to another aspect of the present disclosure, the cleaning kit may further include a frame structured to couple with the rod.

According to another aspect of the present disclosure, the frame is structured to permit relative motion between the frame and the rod in the longitudinal direction of the rod.

According to another aspect of the present disclosure, the rod may be structured to be fixed to the frame at a first position, and may further structured to be fixed to the frame at a second position to permit movement of the rod upward from the first position with respect to the frame.

According to another aspect of the present disclosure, the rod may include: a first stopper supported by the frame at the first position to limit upward movement of the rod; and a second stopper spaced apart from the first stopper in the longitudinal direction of the rod, and supported by the frame at the second position to limit the upward movement of the rod.

According to another aspect of the present disclosure, when the upward movement of the rod has been limited by the second stopper at the second position, the first stopper may be supported by the frame to limit downward movement of the rod to permit the rod to be fixed to the frame.

According to another aspect of the present disclosure, the rod may include a third stopper, when the upward movement of the rod has been limited by the first stopper at the first position, the third stopper may be supported by the frame to limit downward movement of the rod to permit the rod to be fixed to the frame.

According to another aspect of the present disclosure, the rod may include a first rod from which the first stopper and the second stopper protrude to an outside of the rod, the first rod may include a pair of first rods that are elongated and spaced apart from each other. The first rod may be able to be bent in a thickness direction to narrow a distance between the pair of first rods, thereby releasing a support of the first stopper or the second stopper by the frame.

Referring to FIGS. 1 to 36, a cleaning kit according an aspect of the present disclosure may include: a frame; a rod having an elongated shape and protruding from the frame; a blade coupled to one end of the rod that protrudes from the frame; a cap detachably coupled to the frame and surrounding one side of the rod and the blade; and a pair of pushers protruding from the cap toward the rod and disposed opposite each other with respect to the rod. The rod may be configured to move in a longitudinal direction thereof with respect to the frame, and the pair of pushers may be configured to move toward the rod so as to press opposite sides of the rod to thereby cause the rod to move.

According to another aspect of the present disclosure, the rod may be configured to be fixed to the frame at a first position, and may be fixed to the frame at a second position moved upward from the first position with respect to the frame.

According to another aspect of the present disclosure, the rod may include a first stopper supported by the frame at the first position so as to limit upward movement of the rod; and a second stopper spaced apart from the first stopper in the longitudinal direction of the rod, and supported by the frame at the second position so as to limit upward movement of the rod.

According to another aspect of the present disclosure, the rod may include a first rod from which the first stopper and the second stopper protrude to an outside of the rod, the first rod being provided as a pair of first rods elongated and spaced apart from each other. The first rod may be configured to be bent in a thickness direction thereof so as to narrow a distance between the pair of first rods, thereby releasing a supported state of the first stopper or the second stopper by the frame.

According to another aspect of the present disclosure, the pair of pushers may press the pair of first rods, respectively, so that the first rod may be bent in the thickness direction.

According to another aspect of the present disclosure, when the upward movement of the rod is limited as the second stopper is supported by the frame at the second position, the first stopper may be supported by the frame to thereby limit downward movement of the rod, allowing the rod to be fixed to the frame.

According to another aspect of the present disclosure, the rod may further include a third stopper. When the upward movement of the rod is limited as the first stopper is supported by the frame at the first position, the third stopper may be supported by the frame to thereby limit downward movement of the rod, allowing the rod to be fixed to the frame.

According to another aspect of the present disclosure, the pusher may include a first pusher penetrating from an inside to an outside of the cap so as to protrude to the outside of the cap; and a second pusher interlocked with the first pusher and protruding toward the inside of the cap.

According to another aspect of the present disclosure, the cleaning kit may further include a rib supporting the second pusher in the longitudinal direction of the rod.

According to another aspect of the present disclosure, the rod may further include a depressed portion formed by recessing a periphery of an end of the rod so as to allow the pusher to be inserted therein and engaged therewith.

According to another aspect of the present disclosure, the pusher may have a restoring force acting toward the outside of the cap.

According to another aspect of the present disclosure, the cap may support the blade in the longitudinal direction of the rod.

According to another aspect of the present disclosure, the blade may include a blade edge defining an edge at an end thereof; and a pair of blade chamfers inclined obliquely from the blade edge to opposite sides. The cap may include a positioning portion that supports the blade chamfer and has a slope corresponding to the blade chamfer so as to align a position of the cap with respect to the rod.

According to another aspect of the present disclosure, the rod may protrude to opposite sides of the frame. The blade may include: a first blade coupled to one end of the rod; and a second blade coupled to another end of the rod. The cap may include a first cap detachably coupled to one side of the frame, surrounding the first blade, and provided with the pusher; and a second cap detachably coupled to another side of the frame and surrounding the second blade.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

What is claimed is:

1. A cleaning kit comprising:
a rod that is elongated in a longitudinal direction;
a first blade protruding from one end of the rod;
a second blade protruding from another end of the rod, wherein the second blade is shaped to define a blade hole at an end of the second blade and along the longitudinal direction of the rod; and a pin protruding from an end of the first blade.

2. The cleaning kit of claim 1, wherein a width of the first blade is less than a width of the second blade.

3. The cleaning kit of claim 1, wherein the first blade comprises:
a first blade edge defining an edge at the end of the first blade; and
a pair of first blade chamfers inclined obliquely from the first blade edge and extending to opposite sides of the first blade.

4. The cleaning kit of claim 1, wherein the second blade comprises:
a second blade edge defining an edge at the end of the second blade; and
a pair of second blade chamfers inclined obliquely from the second blade edge and extending to opposite sides of the second blade.

5. The cleaning kit of claim 1, wherein the pin comprises a pin blade protruding from a center of the end of the first blade, wherein the pin blade defines an outer circumferential surface of a portion of the pin and includes a repeating concave shape.

6. The cleaning kit of claim 5, wherein the pin blade has a serration shape.

7. The cleaning kit of claim 1, wherein the pin comprises a pin tip located at an end of the pin, wherein the pin tip includes a tapered protruding shape.

8. The cleaning kit of claim 1, wherein the blade hole has a cylindrical shape.

9. The cleaning kit of claim 1, wherein the first blade and the second blade are coupled to engage with the rod in a circumferential direction, wherein the engage with the rod limits rotation of the first blade and the second blade in the circumferential direction relative to the rod.

10. The cleaning kit of claim 9, wherein the pin is sized to be inserted into the first blade and is coupled to engage with the first blade in the circumferential direction, wherein the engaging of the pin with the first blade limits rotation of the pin in the circumferential direction relative to the first blade.

11. The cleaning kit of claim 1, further comprising a frame structured to couple with the rod.

12. The cleaning kit of claim 11, wherein the frame is structured to permit relative motion between the frame and the rod in the longitudinal direction of the rod.

13. The cleaning kit of claim 12, wherein the rod is structured to be fixed to the frame at a first position, and further structured to be fixed to the frame at a second position to permit movement of the rod upward from the first position with respect to the frame.

14. The cleaning kit of claim 13, wherein the rod comprises:
a first stopper supported by the frame at the first position to limit upward movement of the rod; and
a second stopper spaced apart from the first stopper in the longitudinal direction of the rod, and supported by the frame at the second position to limit the upward movement of the rod.

15. The cleaning kit of claim 14, wherein when the upward movement of the rod has been limited by the second stopper at the second position, the first stopper is supported by the frame to limit downward movement of the rod to permit the rod to be fixed to the frame.

16. The cleaning kit of claim 14, further comprising:
a third stopper, wherein when the upward movement of the rod has been limited by the first stopper at the first position, the third stopper is supported by the frame to limit downward movement of the rod to permit the rod to be fixed to the frame.

17. The cleaning kit of claim 14, wherein the rod comprises a first rod from which the first stopper and the second stopper protrude to an outside of the rod, the first rod comprising a pair of first rods that are elongated and spaced apart from each other, and
wherein the first rod is able to be bent in a thickness direction to narrow a distance between the pair of first rods, thereby releasing a support of the first stopper or the second stopper by the frame.
